(19) United States
(12) Patent Application Publication
(10) Pub. No.: US 2004/0025727 A1
(43) Pub. Date: Feb. 12, 2004

(54) Self-inking hand stamp with a reversing type element and kit containing such a self-inking stamp

(76) Inventor: Ernst Faber, Wels (AT)

Correspondence Address: WILLIAM COLLARD, COLLARD & ROE, P.C., 1077 NORTHERN BOULEVARD, ROSLYN, NY, 11576, US

(21) Appl. No.: 10/450,343

(22) PCT Filed: Dec. 11, 2001
(86) PCT No.: PCT/AT01/00392

(30) Foreign Application Priority Data
Jan. 26, 2001 (AT) GM 66/2001

(51) Int. Cl. B41K 1/40

(52) U.S. Cl. 101/333

(57) ABSTRACT

The invention relates to a self-inking hand stamp (1) with a type element (2) that can be reversed by means of a reversing mechanism (7) and that carries stationary (3) and exchangeable (4) stamp types one beside the other. At least one stamp plate (17) that carries stationary stamp types (3) is disposed on the type element (2). The type element (2) is further provided with at least one recess (18) in which insertion projections (19) for exchangeable stamp types (4) can be inserted. A kit (26) comprising such a hand stamp (1) has a container (27) in which, in addition to the hand stamp (1), stamp types (4) and a tool (30) for inserting said stamp types are arranged.

The invention relates to a self-inking hand stamp comprising a pivotable character unit, said character unit carrying adjacently arranged stationary stamp characters and exchangeable stamp characters and being arranged to be upwardly and downwardly movable in a hollow, downwardly open housing and connected to a turning mechanism by which the stamp characters are alternately pressed against an ink pad arranged in the housing and against a surface to be provided with an imprint, to which the housing is pressed with its open lower side, a manipulating means for actuating the turning mechanism being provided on the housing so as to be shiftable relative to the latter, pressing downward of said manipulating means moving the character unit with the stamp characters located thereon from the inking pad against the surface to be imprinted when the lower side of the stamp housing has been applied to the surface to be imprinted, and pressing the stamp characters at the surface to be imprinted. Moreover, the invention relates to a kit comprising such a self-inking hand stamp.

Self-inking hand stamps of the aforementioned type are known in which changeable stamp characters are arranged on character bands which are guided over adjusting wheels by which the respective desired stamp characters can be selected from the stamp characters provided at the continuous bands and can be brought into a position adjacent the stationary stamp characters. Such stamps are known from AT 383 993, e.g.. In such known stamps, the character unit comprises the guides and the adjustment means for changeable stamp characters in addition to a carrier for the stationary stamp characters, and this character unit which, due to the presence of the character bands carrying the exchangeable stamp characters and of the adjustment means provided for these character bands, is rather voluminous, is in its entirety alternately pressed against an inking pad and a surface to be imprinted by carrying out a pivotal movement of 180°. From this there results a comparatively large structure of such hand stamps, on the one hand, and a limitation as regards the exchange of characters possible, on the other hand, since only a comparatively low number of different stamp characters can be accommodated on the character bands.

It is an object of the present invention to provide a self-inking hand stamp of the initially defined type which can be designed with substantially smaller dimensions while having a simple construction and with which, if required, application of a much larger variety of the exchangeable stamp characters is possible.

The self-inking hand stamp according to the invention is characterized in that the character unit comprises a stamp plate carrier on which at least one stamp plate carrying stationary stamp characters is arranged and which, moreover, has at least one recess in which plug-in projections shaped corresponding to this recess and located on the rear side of stamp characters provided to be exchanged, are insertable in a snug fit. By this design, the aforementioned objects can well be met, and with a simple construction, a reliable, uniform inking of all stamp characters and a clean, uniform imprint of the latter can be attained. For handling during an exchange of the stamp characters provided for this, and also for attaining the uniform inking mentioned and a uniform imprint with the simplest structural embodiment of the stamp, it is advantageous if it is provided for the stamp plate that carries the fixed stamp characters and for the stamp characters provided for an exchange to be made of a soft elastic rubber or synthetic material in a manner known per se. For positioning the stamp characters provided to be exchanged it is, furthermore, advantageous if it is provided for the stamp plate carrying the fixed stamp characters to have an opening which surrounds the recess provided on the stamp plate carrier, two oppositely arranged sides of the rim of this opening being located at a distance from each other which corresponds to the dimension of stamp characters provided to be exchanged and insertable in the recess. For the manipulation during the exchange of the stamp characters provided for this purpose, arresting of the character unit in its position located at the lower bottom side of the housing is helpful, and according to a structurally very simple embodiment of the inventive stamp therefore one opening each is provided in the housing of the stamp and in the manipulating means, which is dimensioned for a thin pin to be inserted therethrough, these two openings being aligned with each other in the pressed-down position of the manipulating means, in which the character unit is located at the open, lower side of the housing.

Since in the self-inking hand stamp designed according to the invention the stamp characters provided for an exchange are kept ready in a loose state, they are not subject to limitations in terms of variety as exist in the usual self-inking hand stamps with exchangeable stamp characters arranged on bands, and this is advantageous both as regards the possibilities available to the individual user and to the production of stamps and their stock-keeping.

The kit according to the invention with the self-inking hand stamp of the aforementioned type is characterized in that the kit comprises the self-inking hand stamp and a container in which, in addition to a receiving space for the hand stamp, a carrier for a plurality of stamp characters provided to be exchanged, which carrier is provided with such stamp characters, as well as an insertion tool for these stamp characters is arranged. Such a kit does not only offer a protected receptacle for the stamp, but also provides what is required for the respective desired exchange of stamp characters. The insertion tool may, e.g., be in the form of a suitably shaped pair of tweezers.

The invention will now be explained in more detail and with reference to the examples illustrated in the drawing. In the drawings,

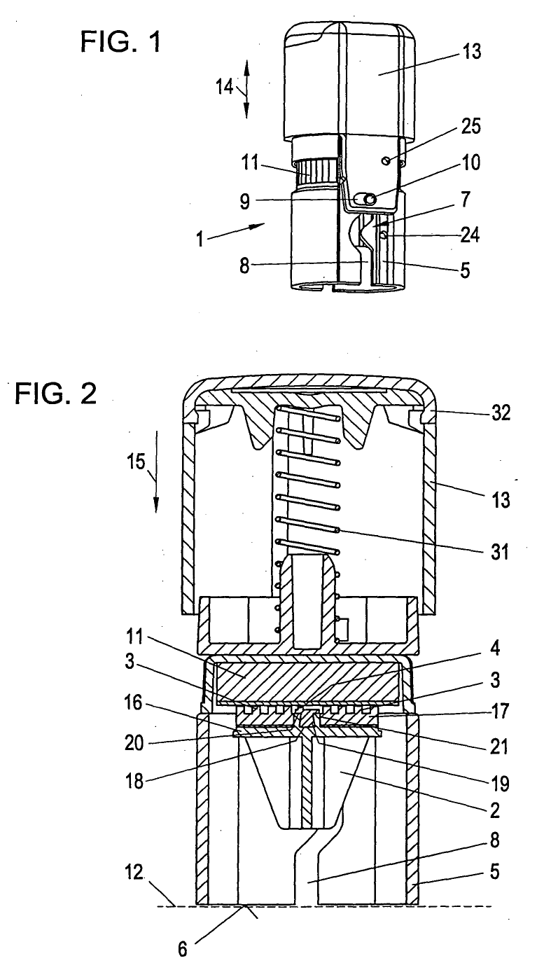

FIG. 1 shows an embodiment of a self-inking hand stamp designed according to the invention in an elevational view,

FIG. 2 shows this stamp in a sectional representation on an enlarged scale,

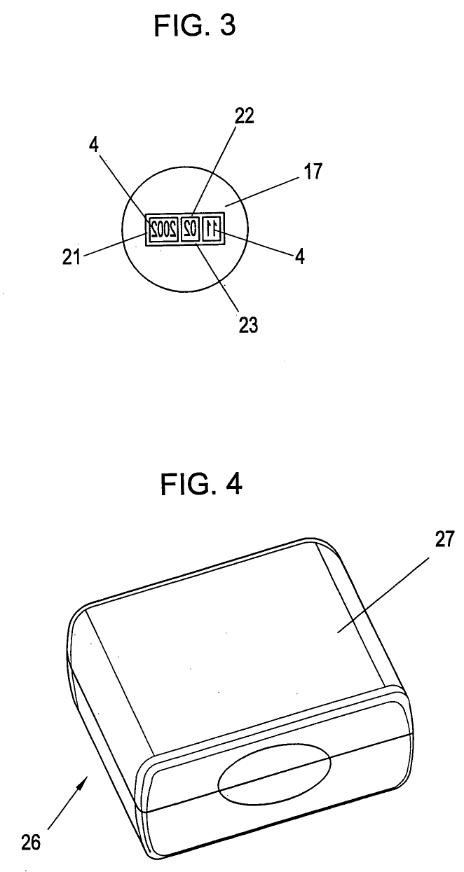

FIG. 3 shows a view of the stamp-character carrying side of the stamp plate carrier of the stamp illustrated in FIGS. 1 and 2, and

FIGS. 4 to 6 show views of a kit provided with such a hand stamp.

The embodiment illustrated in FIGS. 1 and 2 of a self-inking hand stamp 1 designed according to the invention comprises a pivotable character unit 2 carrying adjacently arranged stationary stamp characters 3 and exchangeable stamp characters 4, and this character unit 2 is arranged in a hollow, downwardly open housing 5 so as to be upwardly and downwardly movable therein. The character unit 2 is connected to a turning mechanism 7 by means of which the stamp characters 3, 4 are alternately pressed against an inking pad 11 arranged within the housing 5 and against a surface 12 to be imprinted at which the housing 5 is applied with its open lower side 6. The turning mechanism 7 is constructed with a curved path 8 arranged in housing 5, and a transverse slot 9 as well as pins 10 which provide for a movable connection between housing 5, the manipulating means 13 and the character unit 2 and which, when actuating a manipulating means 13 provided on the housing 5, effect the aforementioned movement of the stamp characters. Such a turning mechanism is described in U.S. Pat. No. 3,359 897, e.g. In the resting position of the stamp, the manipulating means 13 is pressed upwards by a spring 31, and this has the effect that the stamp characters 3, 4 provided on the character unit 2 are pressed against the ink pad 11 arranged in housing 5. As indicated by double arrow 14, the manipulating means 13 is arranged on housing 5 so as to be shiftable relative to the latter, and by pressing down the manipulating means 13 in the direction of arrow 15, when the lower side 6 of the housing 5 of the stamp rests on the surface 12 to be imprinted, the character unit 2 with the stamp characters 3, 4 provided thereon can be moved from the inking pad 11 towards the surface 12 to be imprinted, and the stamp characters 3, 4 can be pressed against the surface 12 to be imprinted. In the course of pressing down the manipulating means 13, the character unit 2, while moving from the inking pad 11 to the surface 12 to be imprinted, will experience a pivotal movement of 180° by means of the aforementioned turning mechanism 7.

A stamp plate 17 carrying stationary stamp characters 3 is arranged on the stamp plate carrier 16 of the character unit 2, and the stamp plate carrier 16 furthermore has a recess 18 into which plug-in projections 19, shaped correspondingly to this recess 18 and arranged on the rear side of stamp characters 4 to be exchanged, are inserted in a snug fit. The stamp characters 4 provided to be exchanged can easily be pulled out of recess 18 and replaced by other, desired stamp characters when the character unit 2 is in its position at the lower side 6 of housing 5 and thus the imprinting surfaces of the stamp characters are oriented to the outside through the opening provided on the lower side 6 of housing 5. The snug fit of the stamp characters 4 in recess 18 also provides for a secure lateral positioning in a simple manner. In height direction, any tolerances possibly present which may result when inserting in recess 18 the stamp characters provided to be exchanged, are equalized when the stationary stamp characters 3 and the exchangeable stamp characters 4 together are pressed against the inking pad, and possibly also when they are pressed against the surface 12 to be imprinted. It is advantageous both for such equalizing and also for the handling when inserting the stamp characters 4 if the stamp plate 17 carrying the stationary stamp characters 3 and the stamp characters 4 provided to be exchanged are made of a soft elastic rubber or synthetic material. For a lateral positioning of the stamp characters 4 provided to be exchanged it is advantageous if, as is apparent from FIG. 3, the stamp plate 17 carrying the stationary stamp characters 3 has an opening 21 surrounding the recess (cf. FIG. 2) provided on the stamp plate carrier 16, two oppositely arranged sides 22, 23 of the rim of this opening 21 having a distance from each other which corresponds to the dimension of the stamp characters 4 which can be inserted in recess 18.

To allow for a simple arresting of the character unit 2 in its position at the open lower side of housing 5, an opening 24 is provided in housing 5 of stamp 1 and an opening 25 is provided in the manipulating means 13 of the stamp, which openings 24, 25 are dimensioned for a thin pin, e.g. a bent-apart wire clip, to be pushed therethrough, and these two openings 24, 25 are located such that they are in alignment in the pressed-down position of the manipulating means 13 in which the character unit 2 is located at the open lower side of housing 5.

On the upper side of manipulating means 13 an inspection window 32 is provided below which a stamp imprint may be placed.

In the embodiment of a kit 26 designed with a self-inking hand stamp according to the invention and illustrated in FIGS. 4 to 6, a container 27 designed as a case with snap-lid is provided, in which in addition to a receiving space for the hand stamp 1, a carrier 29 is accommodated which receives a plurality of stamp characters 4 provided to be exchanged.

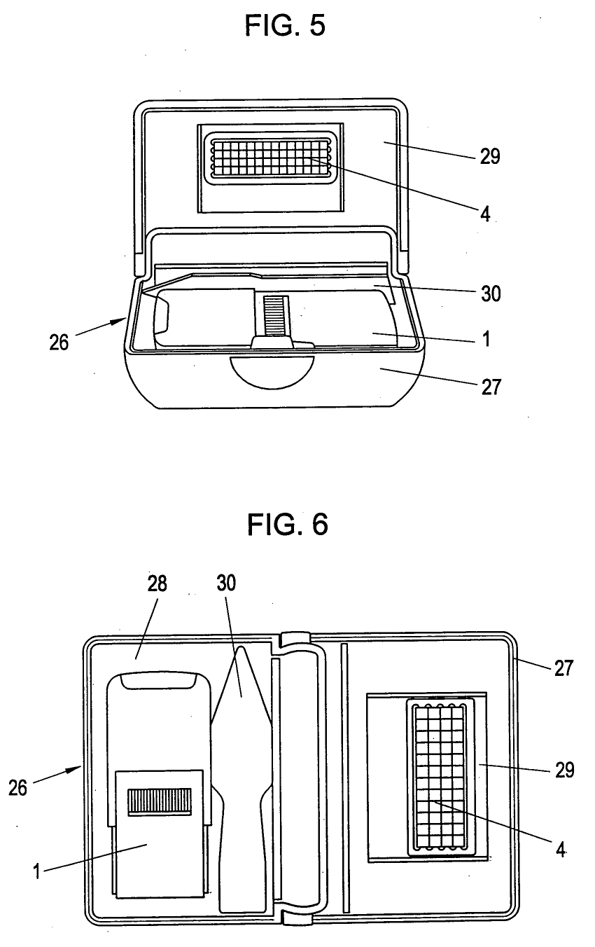

In the container 27 which is illustrated in its closed state in FIG. 4 and in open states in FIGS. 5 and 6, furthermore an insertion tool 30 in the form of tweezers is removably arranged, said tweezers being designed for handling the stamp characters 4.

1. A self-inking hand stamp comprising a pivotable character unit, said character unit carrying adjacently arranged stationary stamp characters and exchangeable stamp characters and being arranged to be upwardly and downwardly movable in a hollow, downwardly open housing and connected to a turning mechanism by which the stamp characters are alternately pressed against an ink pad arranged in the housing and against a surface to be provided with an imprint and to which the housing is pressed with its open lower side, a manipulating means for actuating the turning mechanism being provided on the housing so as to be shiftable relative to the latter, pressing downward of said manipulating means moving the character unit with the stamp characters located thereon from the inking pad against the surface to be imprinted when the lower side of the stamp housing has been applied to the surface to be imprinted, and pressing the stamp characters at the surface to be imprinted, characterized in that the character unit (2) comprises a stamp plate carrier (16) on which at least one stamp plate (17) carrying stationary stamp characters (3) is arranged and which, moreover, has at least one recess (18) in which plug-in projections (19), shaped corresponding to this recess (18) and located on the rear side of stamp characters (4) provided to be exchanged, are insertable in a snug fit.

2. A self-inking hand stamp according to claim 1, characterized in that the stamp plate (17) carrying the stationary stamp characters (3) and the stamp characters (4) provided to be exchanged consist in a per se known manner of a soft-elastic rubber or synthetic material.

3. A self-inking hand stamp according to claim 1 or 2, characterized in that the stamp plate (17) carrying the stationary stamp characters (3) has an opening (21) which surrounds the recess (18) provided on the stamp plate carrier (16), two oppositely arranged sides (22, 23) of the rim of this opening (21) being located at a distance from each other which corresponds to the dimension of stamp characters (4) provided to be exchanged and insertable in the recess (18).

4. A self-inking hand stamp according to any one of claims 1 to 3, characterized in that in the housing (5) of the stamp (1) and in the manipulating means (13), one opening (24, 25) each is provided which is dimensioned for a thin pin to be inserted therethrough, these two openings (24, 25) being aligned with each other in the pressed-down position of the manipulating means (13), in which the character unit (2) is located at the open, lower side (6) of the housing (5).

5. A kit with a self-inking hand stamp according to any one of the preceding claims, characterized in that the kit (26) comprises the self-inking hand stamp (1) and a container (27) in which, in addition to a receiving space for the hand stamp (1), a carrier (29) for a plurality of stamp characters (4) provided to be exchanged, which carrier is provided with such stamp characters, as well as an insertion tool (30) for these stamp characters (4) is arranged.
